(19) United States
(12) Patent Application Publication
(10) Pub. No.: US 2014/0244380 A1
(43) Pub. Date: Aug. 28, 2014

(54) Dynamically Allocating Marketing Results Among Categories

(71) Applicants: Kevin Willeitner, Orem, UT (US); Matt Belkin, Salt Lake City, UT (US)

(72) Inventors: Kevin Willeitner, Orem, UT (US); Matt Belkin, Salt Lake City, UT (US)

(73) Assignee: OMNITURE, INC., Orem, UT (US)

(21) Appl. No.: 12/572,727

(22) Filed: Oct. 2, 2009

(51) Int. Cl. G06Q 10/00; G06Q 30/00

(52) U.S. Cl. 705/14.45

(57) ABSTRACT

A computer-implemented system and method allow an analyst and/or automated system to dynamically adjust the allocation of marketing results among a plurality of categories of marketing items such as channels and/or campaigns. According to various embodiments, a continuous control element, such as a slider, is provided, allowing the analyst to specify an allocation at any point along a continuum. A displayed report is updated substantially instantaneously in response to the analyst's manipulation of the control element, so as to provide dynamic, real-time feedback. According to other embodiments, adjustments to allocations can be made automatically. The displayed report can indicate, for example, revenue, order allocation, average order value (AOV), profit, return on investment, or any other quantitative result(s), and can update these results substantially instantaneously in response to changes in allocations. Graphical and/or textual representations of the quantitative results can be presented and updated.

### CROSS-REFERENCE TO RELATED APPLICATIONS

The present patent application is related to U.S. Utility patent application Ser. No. 12/203,749, filed Sep. 3, 2008, for “Measuring Effectiveness of Marketing Campaigns Across Multiple Channels”, (attorney docket no. OMN90003), which is incorporated herein by reference.

### FIELD OF THE INVENTION

The present invention is related to analysis of marketing campaigns, and more particularly to improved techniques for dynamically allocating the results of marketing efforts among multiple categories.

### DESCRIPTION OF THE BACKGROUND ART

It is relatively common for consumers to be exposed to multiple marketing campaigns and/or channels before they make a purchasing decision. It is useful, for providers of goods or services, to determine the effectiveness of various categories of marketing items, such as campaigns and/or channels, in influencing consumer decisions. Accordingly, providers of goods or services often seek to allocate marketing results, particularly successes, among multiple categories of marketing items, such as campaigns and/or channels, in a manner that accurately reflects the relative contribution of each category of marketing items. In addition, such allocation may be important in determining an appropriate valuation or compensation to be associated with a channel, campaign, or other category.

Marketing analysts are often faced with difficult decisions as to how to allocate marketing results across multiple categories of marketing items. For example, if a consumer initially visits a website by clicking on a paid advertisement, then later visits the website through affiliate marketing, and then makes a purchase, it is useful to allocate credit for the purchase among the two channels to which the consumer was exposed. Credit can be allocated exclusively to the first channel (the paid ad), or exclusively to the second channel (the affiliate), or to some combination of the two. Valuation, compensation, and perceived effectiveness of these marketing channels can vary dramatically depending on how the marketing result is allocated among the channels.

Conventionally, marketing analysts can run multiple reports, each representing a different allocation, in order to see the effect of various allocations. However, it is often difficult to perform meaningful comparisons among multiple separate reports, and it is often cumbersome to run multiple reports in such a manner.

What is needed is a system and method that allows an analyst to see the effect of changing allocations in a dynamic, real-time manner that avoids the inconvenience and limitations of prior art techniques. What is further needed is a system and method that allows an analyst to see the effect of changing allocations without requiring the analyst to run multiple reports.

### SUMMARY OF THE INVENTION

According to various embodiments of the present invention, a computer-implemented system and method are provided that allow an analyst and/or automated system to dynamically adjust the allocation of marketing results among a plurality of categories of marketing items such as channels and/or campaigns. A continuous control element, such as a slider, is provided, allowing the analyst to specify an allocation at any point along a continuum. According to various embodiments, a displayed report is updated substantially instantaneously in response to the analyst's manipulation of the control element, so as to provide dynamic, real-time feedback. According to other embodiments, adjustments to allocations can be made automatically. The displayed report can indicate, for example, revenue, profit, return on advertising spending, return on investment, order allocation, average order value (AOV) or any other quantitative result(s), and can update these results substantially instantaneously in response to the analyst's manipulation of the control element. Graphical and/or textual representations of the quantitative results can be presented and updated.

The present invention thus provides an improved technique for specifying allocation among categories of marketing items such as campaigns and/or channels without requiring the analyst to run multiple reports. Rather, the analyst can easily adjust the allocation and substantially instantaneously view the effects of his or her changes. The invention thus provides improved flexibility and visibility for viewing the effect of allocation decisions.

### BRIEF DESCRIPTION OF THE DRAWINGS

FIG. 1 is a flow diagram depicting a method of dynamically allocating marketing results among categories according to one embodiment of the present invention.

FIG. 2 is a block diagram depicting a system for practicing the present invention according to one embodiment.

FIGS. 3A through 3E show examples of an interactive summary report for dynamically allocating marketing results among categories according to one embodiment of the present invention.

FIGS. 4A through 4E and 5A through 5E show examples of an interactive detailed report for dynamically allocating marketing results among categories according to one embodiment of the present invention.

FIG. 6 is a table depicting an example of data that has been imported from data store into a spreadsheet format according to one embodiment.

FIGS. 7A through 7C depict examples of various categories for marketing items according to various embodiments.

FIG. 8 is a flow diagram depicting a method of allocating marketing results based on a position of a movable element within a slider, according to one embodiment of the present invention.

The Figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The following description and accompanying figures are merely illustrative of the techniques of the invention. One skilled in the art will recognize that the techniques of the invention can be implemented in other ways and in other contexts. In addition, the particular layout and appearance of the screen shots and reports provided herein are intended to be exemplary.

### System Architecture

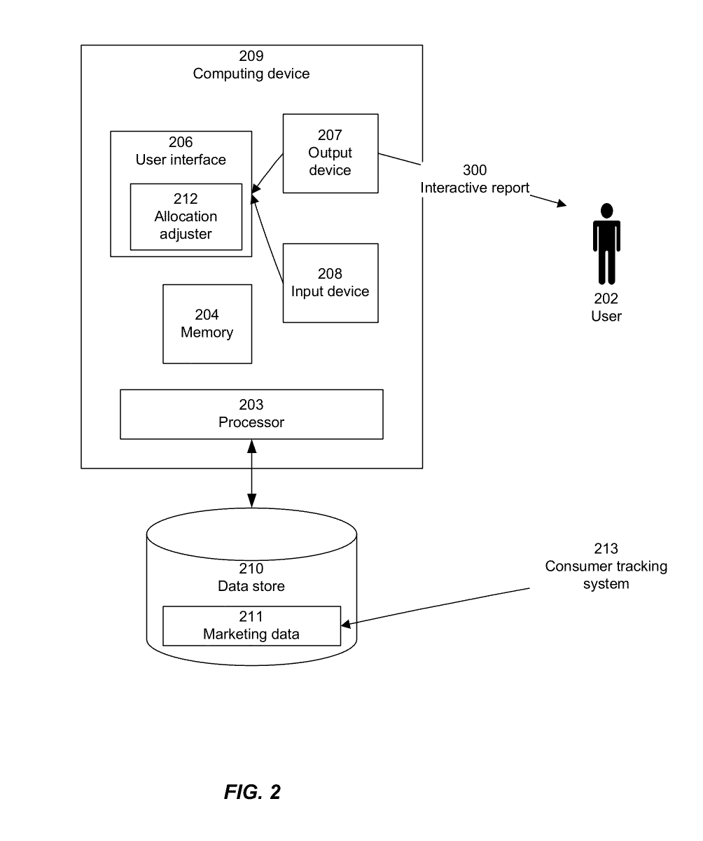

Referring now to FIG. 2, there is shown a block diagram depicting a system for practicing the present invention according to one embodiment. In one embodiment, the invention is implemented on computing device 209 such as a personal computer or similar device. User 202 interacts with computing device 209 via input device 208 (such as a keyboard, mouse, trackpad, or the like, or any combination thereof) and output device 207 (such as a display screen). In one embodiment, computing device 209 contains processor 203 for performing instructions under the direction of software, memory 204 to act as a workspace while performing such instructions, and user interface 206 with which user 202 interacts via input device 208 and output device 207. In one embodiment, computing device 209 may run an operating system such as Microsoft Windows Vista, available from Microsoft Corporation of Redmond, Wash., along with any number of software applications. In one embodiment, the system of the present invention is implemented as software for controlling the operation of processor 203. In another embodiment, the system of the present invention is implemented as web-enabled software that runs on a central server (not shown) in communication with computing device 209 over a network such as the Internet; a browser (not shown) may run on computing device 209 to facilitate user 202 interaction with content from the central server. One skilled in the art will recognize that the techniques described herein can be implemented using any type of computing architecture, and that the particular architecture depicted in FIG. 2 and described herein is merely exemplary. In addition, computing device 209 need not be a computer, but can be any electronic device having input and output functionality, such as for example a personal digital assistant (PDA), cell phone, smartphone, handheld computer, kiosk, or the like.

In one embodiment, computing device 209 generates an interactive report 300 which user 202 (such as a marketing analyst) can view and interact with. Data in interactive report 300 depicts marketing data 211 stored in data store 210. Data store 210 can be any data storage device, whether local or remote with respect to computing device 209. In one embodiment, computing device 209 obtains marketing data 211 from data 210 via a network such as the Internet.

In one embodiment, as described in more detail below, an allocation adjuster 212 is implemented as part of user interface 206, allowing user 202 to interact with report 300 so as to change the parameters of report 300. For example, report 300 may show marketing results, along with an initial allocation among categories, such as channels and/or marketing campaigns, contributing to the results. User 202 can provide input to change the allocation; in response, computing device 209 displays a modified version of report 300 using the newly specified allocation. In one embodiment, user 202 is presented with modified report 300 substantially instantaneously after providing the input, or even while providing the input, so as to enhance the interactivity of report 300 and provide real-time feedback to user 202.

User 202 can provide the input for specifying and/or changing the allocation in any of a number of different ways. In one embodiment, allocation adjuster 212 is implemented as a movable slider control, allowing user 202 to specify the allocation along a continuum of available choices. In one embodiment, computing device 209 dynamically updates interactive report 300 while user 202 moves the slider, thus providing substantially real-time feedback.

As will be described in more detail below, report 300 can take many different forms. In one embodiment, user 202 can select among a summary report or more detailed reports, and can view the effects of the specified allocation changes in each type of report.

In another embodiment, changes to the allocation can take place automatically, either based on a predefined conditions or in accordance with machine learning algorithms or other automated techniques. For example, a software-based system can be implemented wherein various allocations can be evaluated in a systematic matter, and the results of such comparative analysis can be presented in the form of a report.

In one embodiment, the system of the present invention is implemented as an interactive workbook or spreadsheet, running on a spreadsheet application such as Microsoft Excel, available from Microsoft Corporation of Redmond, Wash. In other embodiments, the invention can be implemented as a stand-alone application, web-based or web-enabled application, plug-in for a browser or other application, or the like. For example, the invention can be implemented as a plug-in for an existing customer relationship management (CRM) applications or as a stand-alone system.

One skilled in the art will recognize that the particular platform for implementing the invention can be changed from those described herein, without departing from the essential characteristics of the invention. Furthermore, the particular components and architecture shown in FIG. 2 are merely exemplary; the present invention can be practiced with systems having other components and architectures.

### Data Format

Marketing data 211 stored in data store 210 can take any form, including for example records describing various categories of marketing items, such as campaigns and/or channels, that led up to a certain success or event, such as a purchase on a website. The records in data store 210 can be stored in any format, and can include any desired or relevant information. For example, in one embodiment, the records in data store 210 include information describing a path taken by a website visitor, revenue (actual or estimated) associated with the path, profit, return on ad spend associated with the path, return on investment associated with the path, a number of orders associated with the path, and the like, and/or any combination thereof.

In one embodiment, marketing data 211 describes sequences of marketing items to which consumers have been exposed before making a purchase (or before some other revenue-related event). In one embodiment, each marketing item is described in terms of a categorization methodology, such as by particular item, channel, campaign, or other category. The sequences of marketing items, also referred to as “paths”, often represent a combination of channels and/or campaigns. The various marketing items in each sequence can thus be categorized by channel, campaign, or other categorization methodology, to facilitate analysis as to which categories of marketing items are most effective, and in what order.

In one embodiment, marketing data 211 in data store 210 is obtained from a tracking system 213 that monitors consumer behavior according to techniques that are well known in the art.

In one embodiment, data from data store 210 is imported to a format that can be easily read, transformed, and/or processed by allocation adjuster 212, so as to provide improve responsiveness when user 220 adjusts a parameter. In one embodiment, for example, data from data store 210 is imported into a spreadsheet, such as Excel.

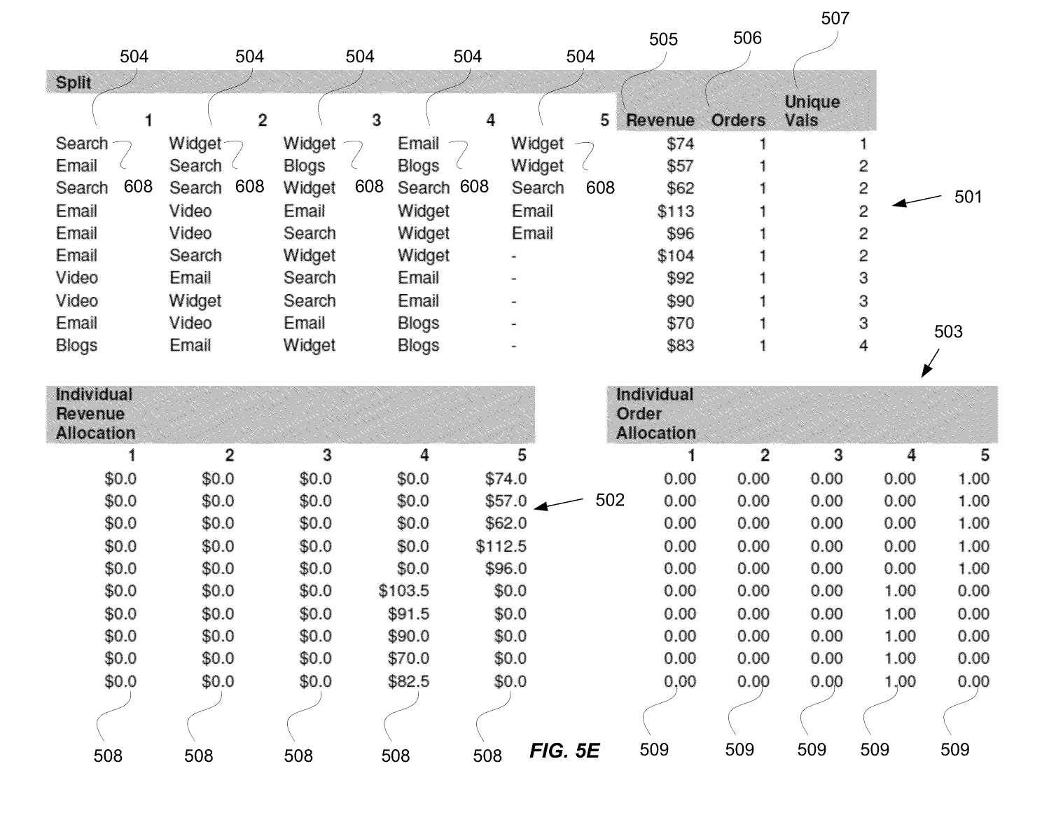

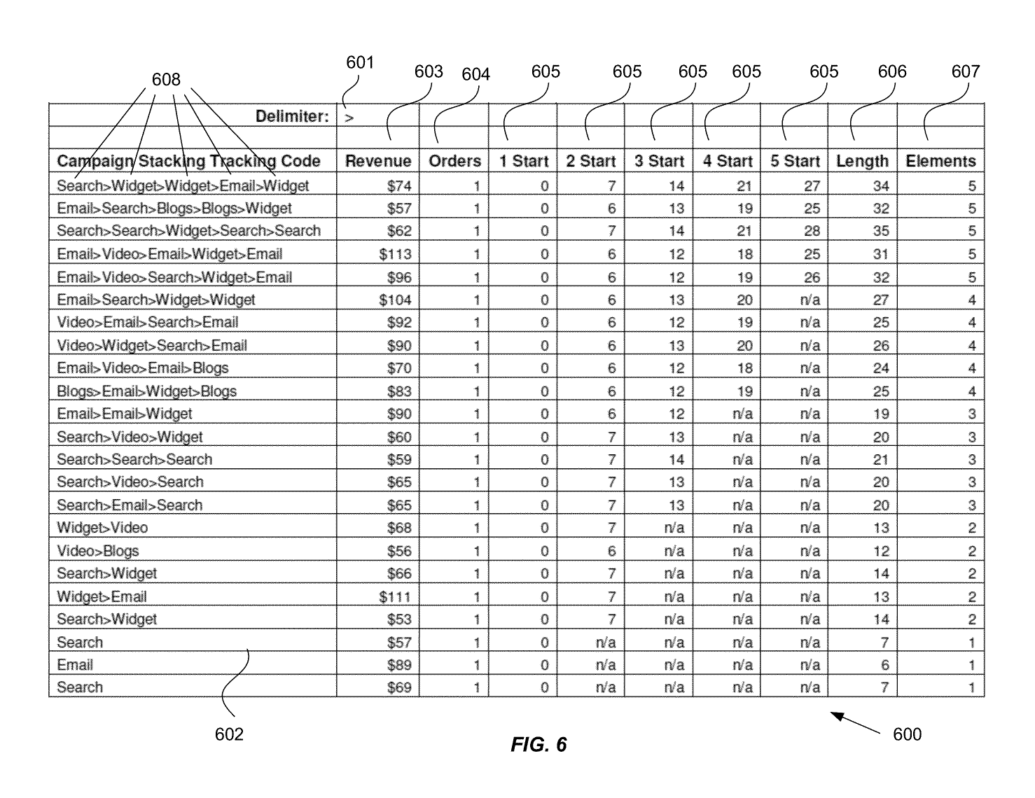

Referring now to FIG. 6, there is shown a table 600 depicting an example of data that has been imported from data store 210 into a spreadsheet format according to one embodiment. Column 602 contains entries describing a particular sequence of exposures to marketing items, also referred to as “touches”. Each entry is presented as a character string, with delimiters separating touch descriptors 608, if two or more touch descriptors 608 are present in a particular character string. In the example, the delimiter is “>”, as indicated in delimiter field 601. Each touch descriptor 608 corresponds to one marketing touch, and specifies the category of the marketing touch. In the particular example, marketing touches are categorized at a channel level.

Column 603 indicates revenue associated with each sequence of touches. Column 603 indicates a quantity of orders associated with each sequence of touches. As mentioned above, other data can be provided in addition to or instead of revenue and orders; for example, some measure of profit, such as return on ad spend or return on investment, can be provided. These can be defined, for example, as (revenue−cost)/cost.

In one embodiment, columns 605, 606, and 607 include calculated fields to assist allocation adjuster 212 in extracting information from table 600. Columns 605 indicate start offsets for touch descriptors 608. Thus, for example, for an entry in column 602 containing the string “Search>Widget>Widget>Email>Widget”, columns 605 contain the values 0, 7, 41, 21, and 27, identifying the starting offsets for touch descriptor 608 as being the 0^{th}, 7^{th}, 41^{st}, 21^{st}, and 27^{th} character of the string. Length column 606 indicates the length of the string in column 602, and elements column 607 indicates the total number of touch descriptors 608 in the string.

### Categories of Marketing Exposures

As described herein, the system and method of the present invention can dynamically allocate marketing results among channels and/or campaigns. In other embodiments, consumer exposures to marketing can be classified by any desired schema. Accordingly, the techniques described herein are not limited to allocations among channels and/or campaigns, but can be applied to allocations among any desired categories. Allocations among channels and/or campaigns are described herein for illustrative purposes; however, one skilled in the art will recognize that the techniques of the present invention can be applied regardless of the defined categories among which allocations are performed.

For example, in one embodiment, the system and method of the present invention is applied to generate allocations at the channel level. This allows an analyst to view progress and success from channel to channel, and to see which combination of channels (and in what sequence) generates the most successful results. Examples of channels include email, pay-per-click advertising, banner advertising on web pages, widget-based advertising, advertisements on mobile devices, television commercials, print advertisements, and the like.

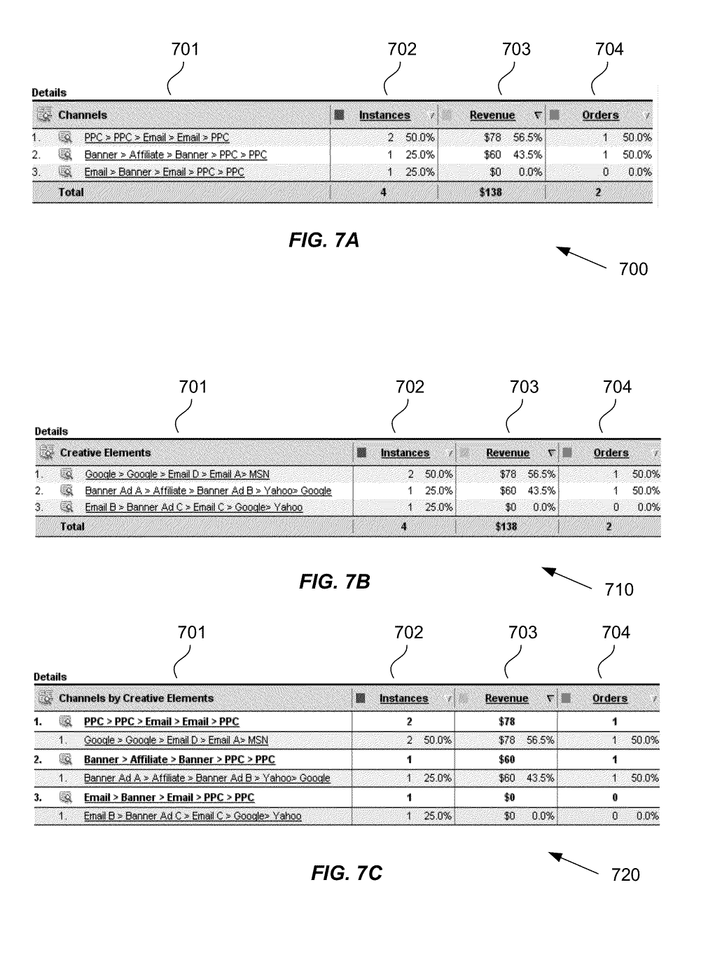

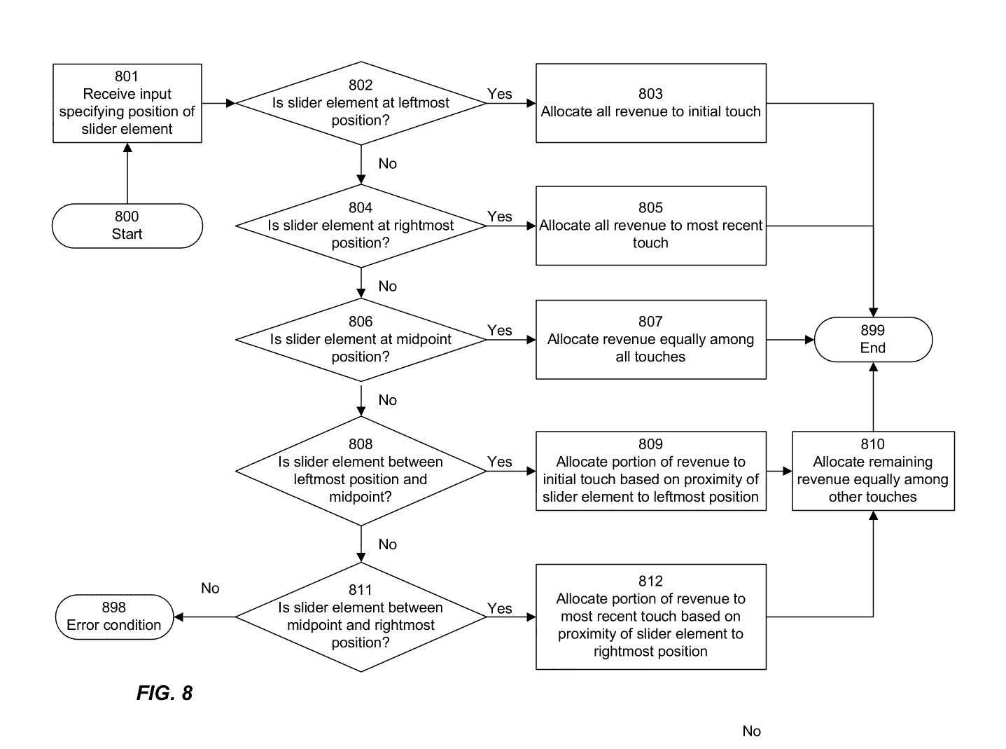

Referring now to FIG. 7A, there is shown a table 700 including examples of sequences of touches described at the channel level. Column 701 includes entries describing sequences of touches. Column 702 includes entries specifying how many instances of each sequence took place. Column 703 indicates revenue associated with each sequence. Column 704 indicates orders associated with each sequence.

In another embodiment, the system and method of the present invention is applied to generate allocations at the creative element level. This allows an analyst to view progress and success based on specific creative elements (ad content), and to see which combination of creative elements (and in what sequence) generates the most successful results. Creative elements can be specified individually, or at the level of a particular brand or source, so as to achieve any desired level of granularity.

Referring now to FIG. 7B, there is shown a table 710 including examples of sequences of touches corresponding to those listed in table 700, but described at the creative element level.

In one embodiment, a hierarchical organization can be employed, wherein channel level descriptions are shown, with each followed by one or more creative element level description(s) to provide more detail. Referring now to FIG. 7C, there is shown a table 720 including such a hierarchical arrangement, wherein channels are specified for sequences, and further detail regarding creative elements is specified at a subordinate level for each sequence.

Thus, in various embodiments, the system and method of the present invention can be applied to generate allocations at any desired level of granularity and along any desired classification or categorization axis.

### Method of Operation

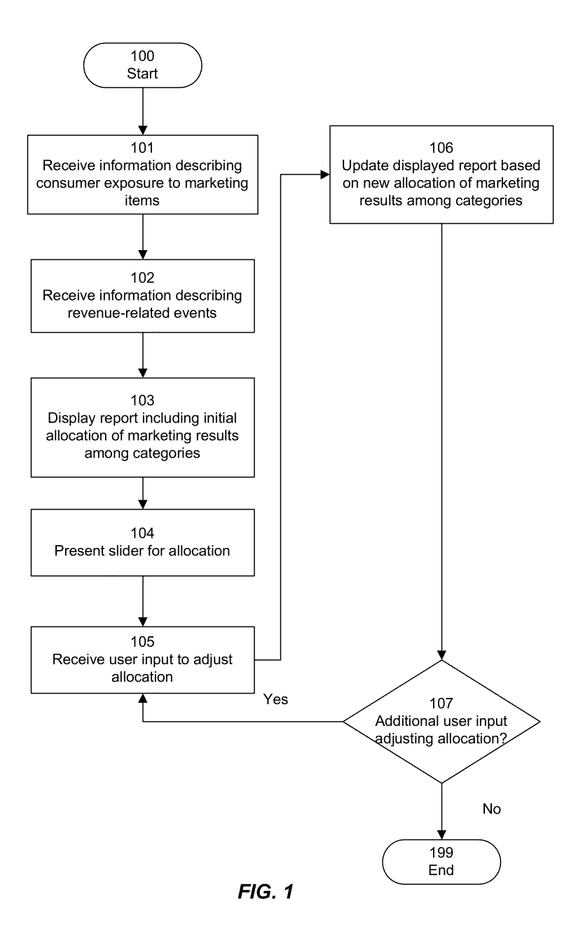

Referring now to FIG. 1, there is shown a flow diagram depicting a method of dynamically allocating marketing results among categories according to one embodiment of the present invention. Allocation adjuster 212 receives 101 information describing touches, or consumer exposure to marketing events, and receives 102 information describing events such as orders, profit, return on investment, and/or revenue associated with orders. Such information can be received 101 from any source, such as marketing data 211 stored in data store 210, or a network-based source, or manual input from a user or administrator.

Allocation adjuster 212 causes output device 207 to display 103 a report including marketing results. Marketing results can be expressed in terms of revenue, number of orders, or any other measure. For events (such as orders) associated with two or more categories, the report depicts an initial allocation among the categories; this initial allocation can be set by default, or configured by user 202, or by an administrator. An interactive interface element such as a slider is presented 104 to show user 202 the initial allocation and to allow user 202 to change the allocation. The operation of the slider will be described in more detail below.

User input is received 105, specifying a change to the allocation. For example, user 202 may move a slider element to specify a new allocation. In response, allocation adjuster 212 updates 106 the displayed report in accordance with the newly specified allocation. As described in more detail below, such update can take place substantially instantaneously upon receipt of user input, and can even provide real-time feedback while user 202 is adjusting the slider element or other user interface control.

A determination is made 107 as to whether any additional user input is received for adjusting the allocation. If so, allocation adjuster 212 returns to step 105 to receive 105 the user input. Otherwise, if no additional user input is received, the method ends 199.

In another embodiment, changes to allocations can be made automatically, for example under the direction of software running on a computer system. In such an embodiment, a set of allocations can be systematically analyzed, and the results of such analysis can be presented in the form of a report.

Additional details concerning the operation of allocation adjuster 212 are presented below.

### User Interface

In one embodiment, the allocation adjuster 212 of the present invention is implemented as an interactive user interface by which user 202 can dynamically adjust allocation of marketing results among various categories such as campaigns and/or channels.

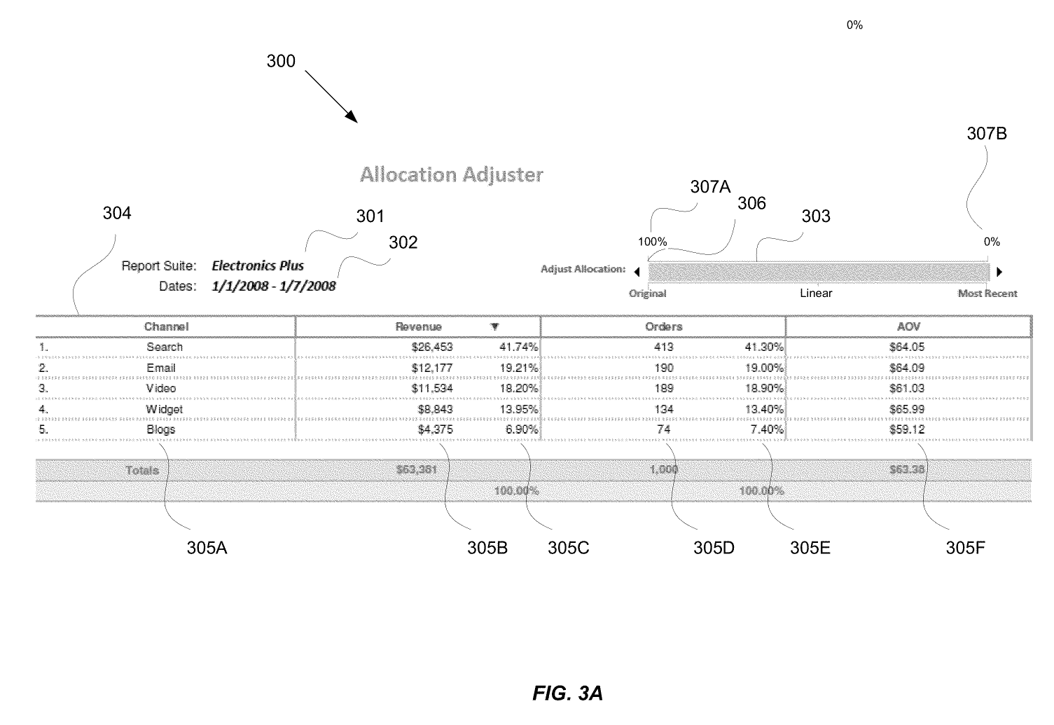

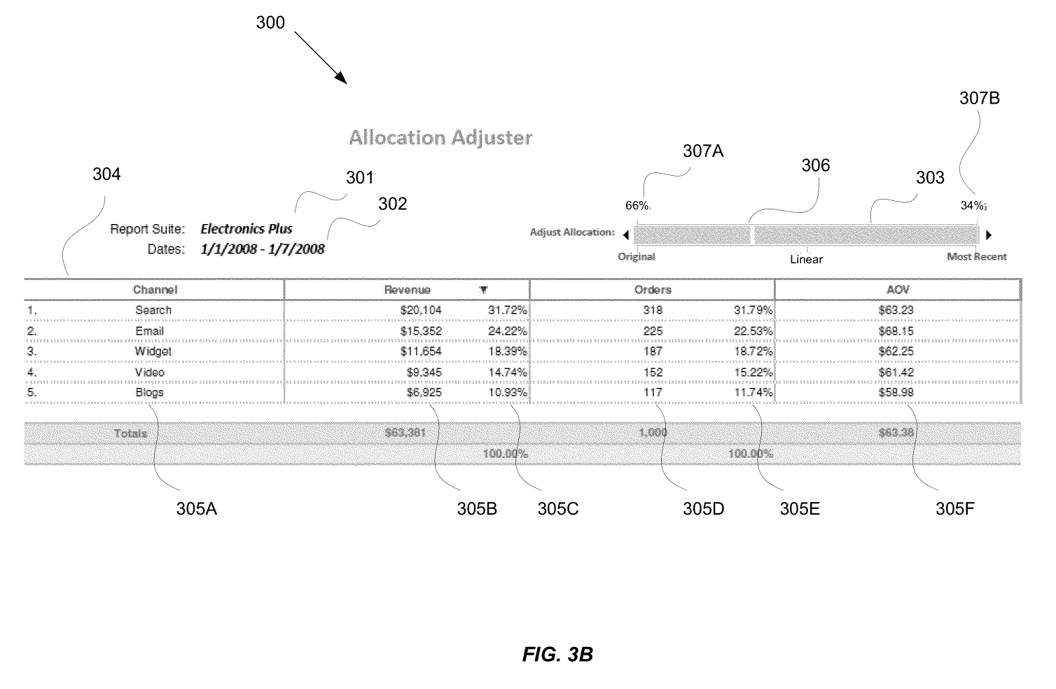

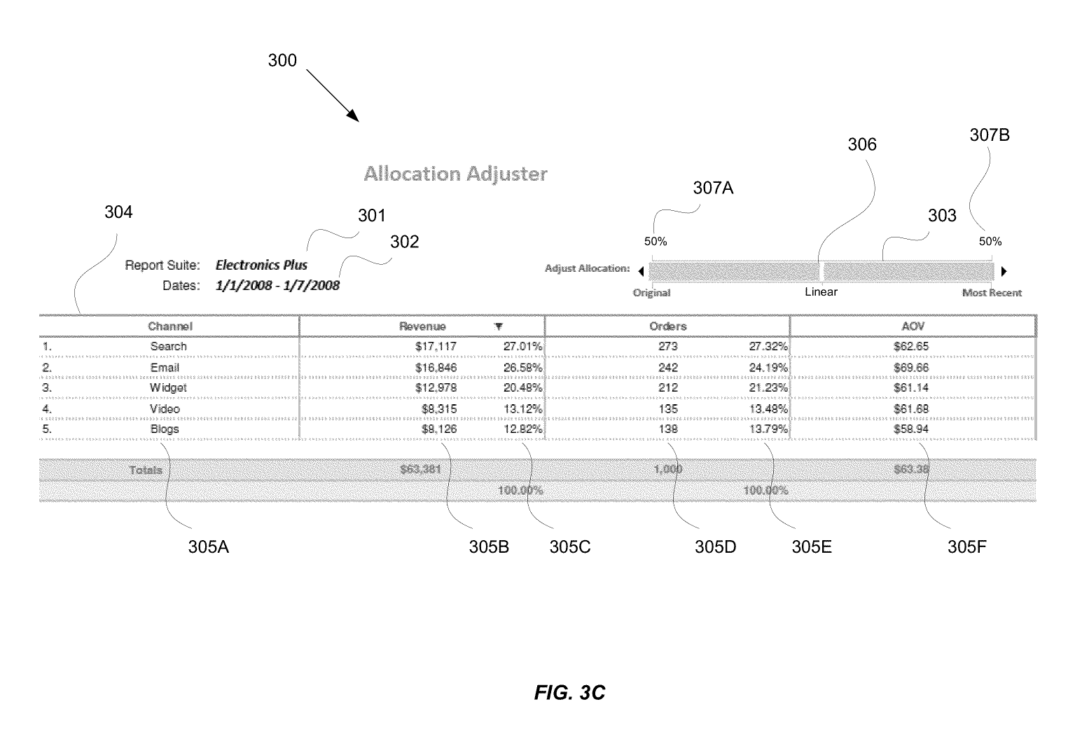

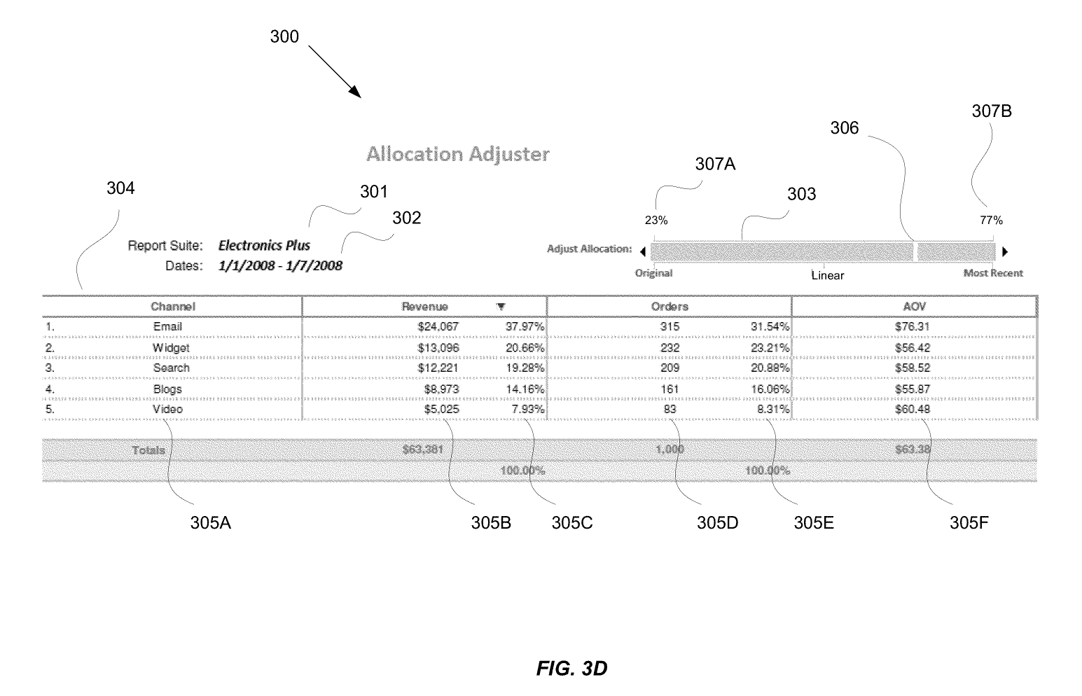

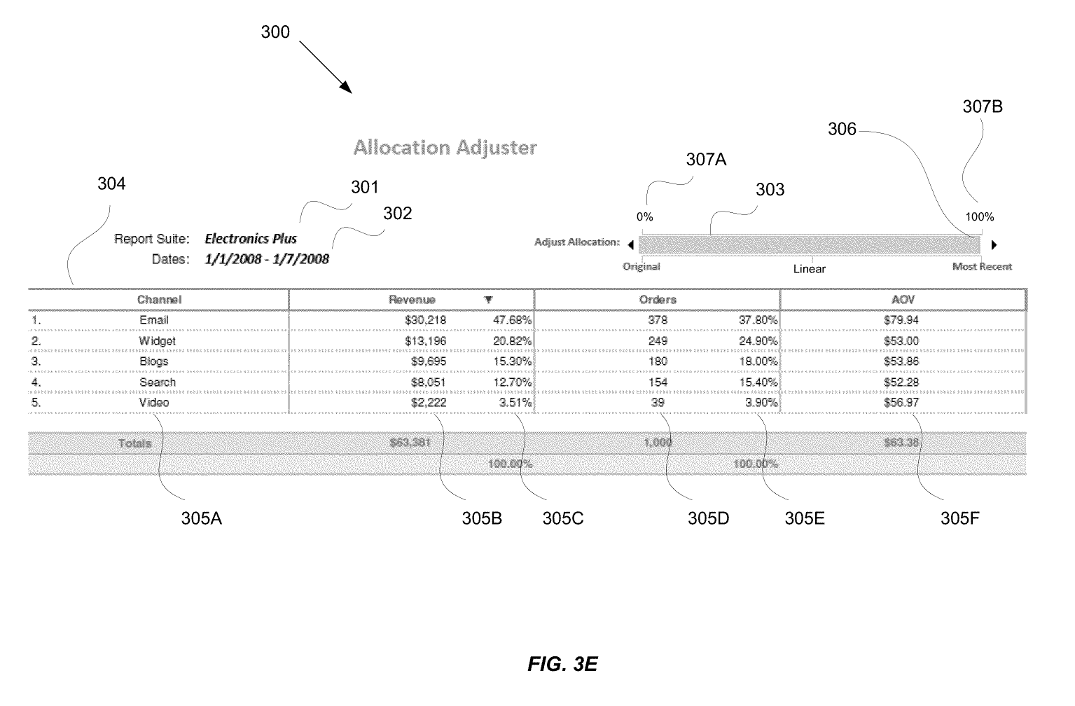

Referring now to FIGS. 3A through 3E, there are shown examples of an interactive summary report 300 for dynamically allocating marketing results among categories according to one embodiment of the present invention. One skilled in the art will recognize that the particular layout shown in the examples are merely illustrative, and that the claimed invention can be implemented with different layouts and elements.

In one embodiment, report 300 includes an identifier 301 of the report suite being depicted, along with a date range 302 for the report. Column 305A lists various categories (in this case channels) that may have contributed to marketing successes. Table 304 includes a summary of allocations assigned to various categories. Revenue columns 305B and 305C indicate revenue allocated to each category as a dollar amount and as a percentage, respectively. Orders columns 305D and 305E indicate order quantities allocated to each category as a dollar amount and as a percentage, respectively. Average order value (AOV) column 605F indicates the average order value based on the values in columns 305B and 305D. In one embodiment, user 202 can indicate how table 304 should be sorted; for example, in FIGS. 3A through 3E, table 304 is sorted based on revenue allocated to each category. One skilled in the art will recognize that other measures of campaign success, such as profit or return on investment, can be provided.

Slider 303 allows user 202 to specify an allocation among categories. Slider 303 includes movable element 306 which can be repositioned at any location along slider 303. In the example, slider 303 is bounded by position 307A representing maximum allocation to the initial (or original) exposure to a marketing item (also referred to as a “touch”), and position 307B representing maximum allocation to the most recent touch. In one embodiment, element 306 has an initial position that may be determined based on user preferences, or on most recent use, or on any other factor.

In one embodiment, movable element 306 specifies allocation among touches as follows:
When element 306 is at a leftmost position within slider 303, all revenue is allocated to the initial touch.
As element 306 is moved to the right, an increasing portion of the revenue is de-allocated from the initial touch and distributed equally among the other touches.
When element 306 is at the midpoint, revenue is allocated equally among all touches.
As element 306 moves to the right of the midpoint, an increasing portion of the revenue is allocated to the last (most recent) touch, with the remaining revenue being distributed equally among the other touches.
When element 306 is at a rightmost position within slider 303, all revenue is allocated to the last (most recent) touch.

Referring now also to FIG. 8, there is shown a flow diagram depicting a method of allocating marketing results based on a position of movable element 306 within slider 303, according to one embodiment of the present invention. Input specifying a position of element 306 is received 801. If, in step 802, element 306 is at the leftmost position, all revenue is allocated 803 to the initial touch; otherwise, the method proceeds to step 804.

If, in step 804, element 306 is at the rightmost position, all revenue is allocated 805 to the most recent touch; otherwise, the method proceeds to step 806.

If, in step 806, element 306 is at the midpoint position, revenue is allocated 807 equally among all touches; otherwise, the method proceeds to step 808.

If, in step 808, element 306 is between the leftmost position and the midpoint position, a portion of revenue is allocated 809 to the initial touch, the portion being based on the proximity of element 306 to the leftmost position. The closer element 306 is to the leftmost position, the greater the portion allocated to the initial touch. Remaining revenue is allocated 810 equally among the other touches. Otherwise, the method proceeds to step 811.

If, in step 811, element 306 is between the midpoint position and the rightmost position, a portion of revenue is allocated 809 to the most recent touch, the portion being based on the proximity of element 306 to the rightmost position. The closer element 306 is to the rightmost position, the greater the portion allocated to the most recent touch. Remaining revenue is allocated 810 equally among the other touches. Otherwise, an error condition is reported 898.

Referring again to FIG. 3A, element 306 is at a leftmost position within slider 303, representing maximum allocation to the initial touch. Thus, table 304 contains allocations based solely on the initial touch for each series of marketing exposures for a particular purchase. In one embodiment, as user 202 moves element 306 along slider, table 304 is automatically updated to reflect the newly specified allocation. Thus, in one embodiment values in columns 305B to 305F are updated, and in one embodiment the rows of table 304 are dynamically re-sorted to reflect the newly specified allocation. Such changes can take place while user 202 moves element 306, such as via a drag-and-drop operation, or after user 202 releases element 306 upon completion of a drag-and-drop operation.

FIGS. 3B through 3E depict report 300 after user 202 has moved element 306 to various positions along slider 303. In each example, the various values in columns 305B to 305F have been updated, and the rows of table 304 have been re-sorted according to total revenue associated with each channel. In FIG. 3B, element 306 is at a position between the leftmost position and the midpoint of slider 303. In FIG. 3C, element 306 is at the midpoint of slider 303, indicating approximately equal allocation between original and most recent touches. In FIG. 3D, element 306 is at a position between the rightmost position and the midpoint of slider 303. In FIG. 3E, element 306 is at the rightmost position and the midpoint of slider 303, indicating 100% allocation to the most recent touch for each series of touches.

In one embodiment, user 202 can also view the calculations that contribute to the results shown in report 300. In one embodiment, a detailed report showing such calculations is presented, and can be made interactive so that user 202 can see the effect of moving element 306 on the detailed report. In this manner, user is given insight into how the changes to allocation affect various calculations resulting in the summary shown in report 300.

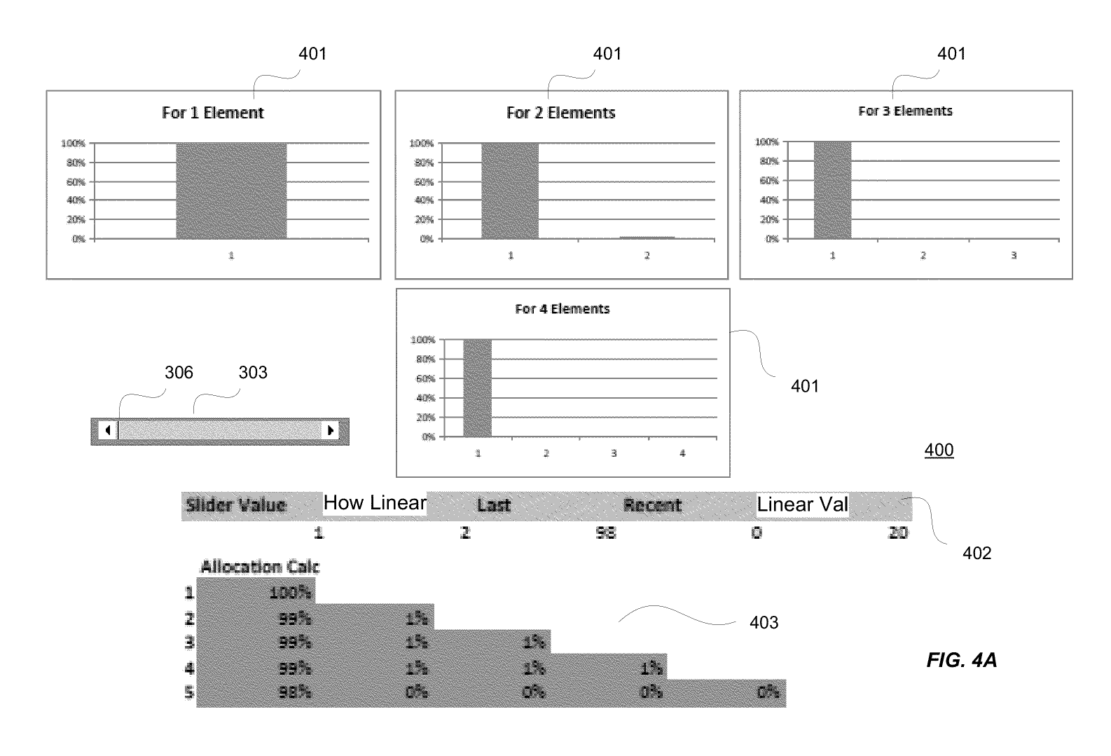

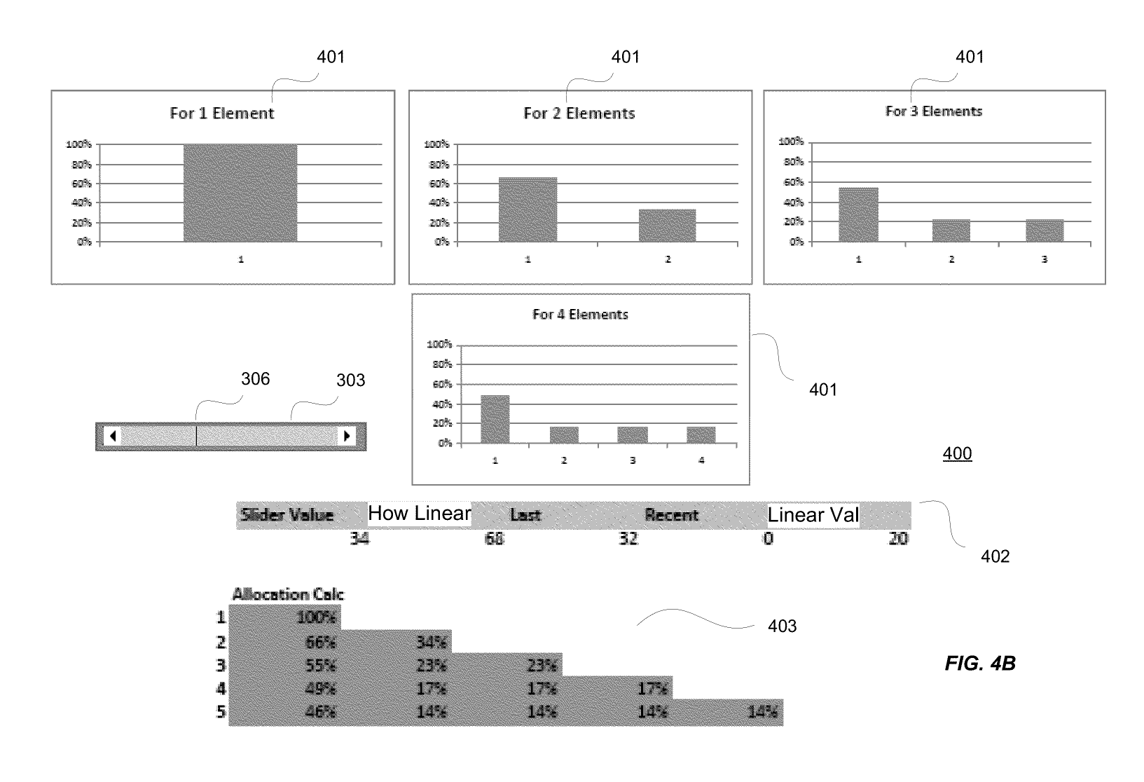

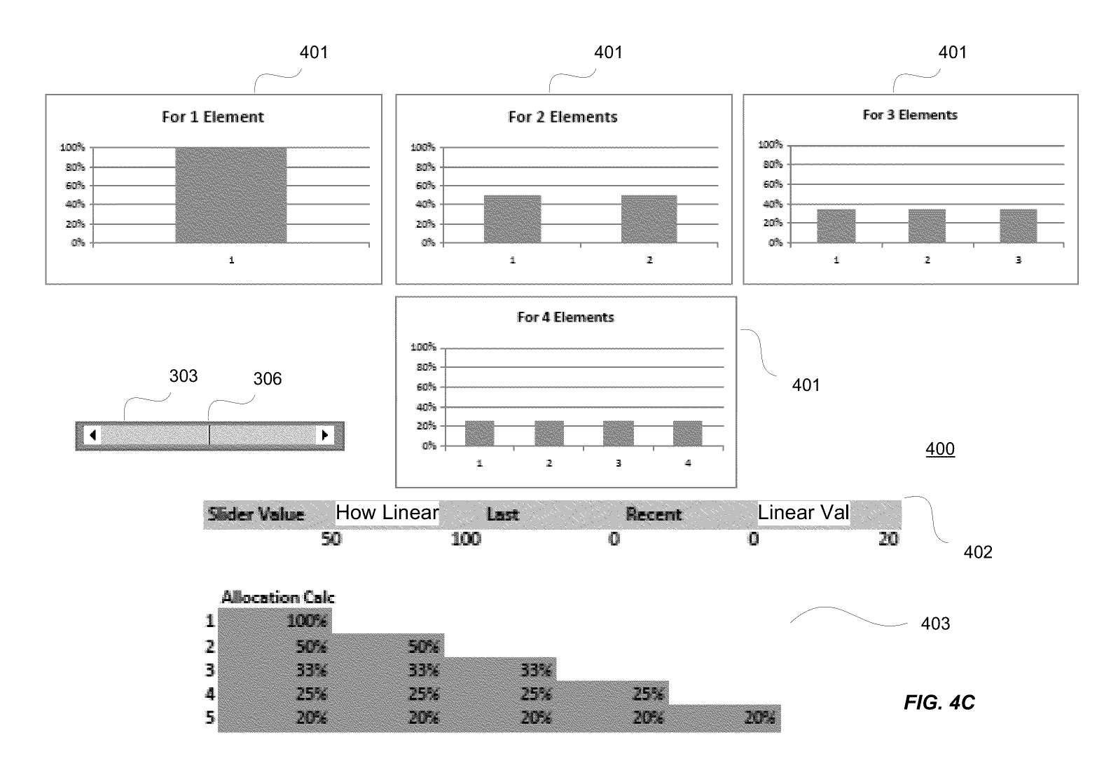

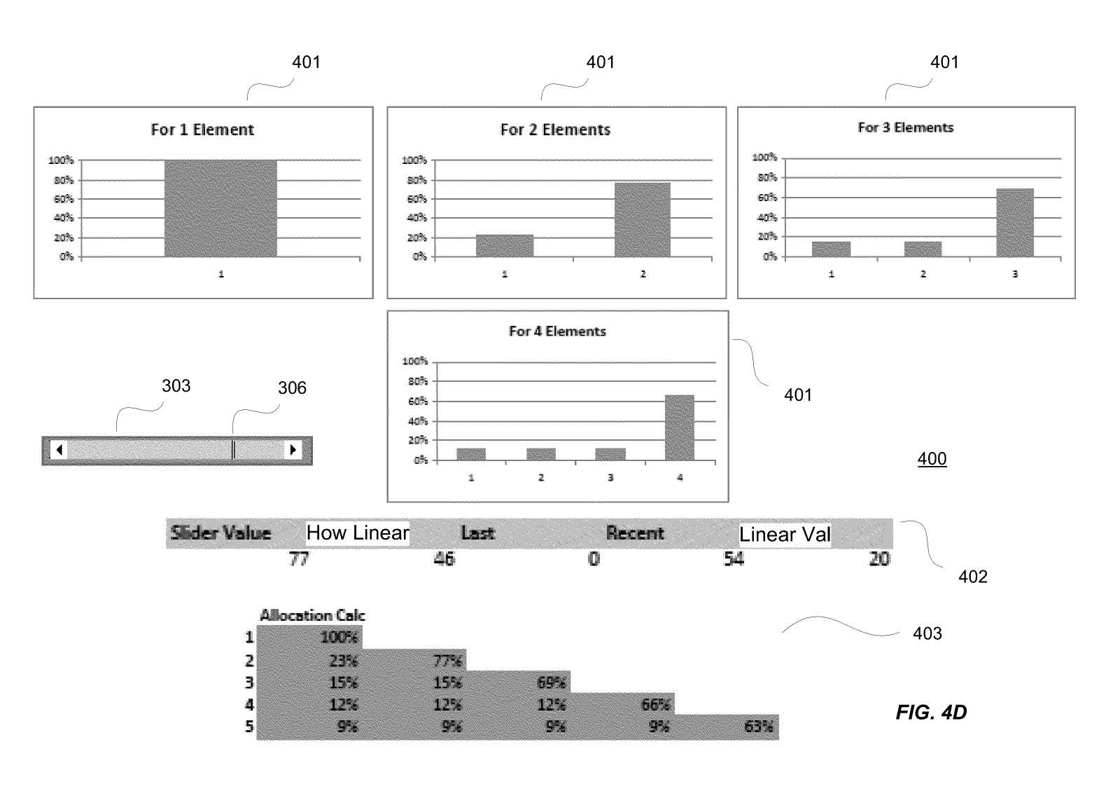

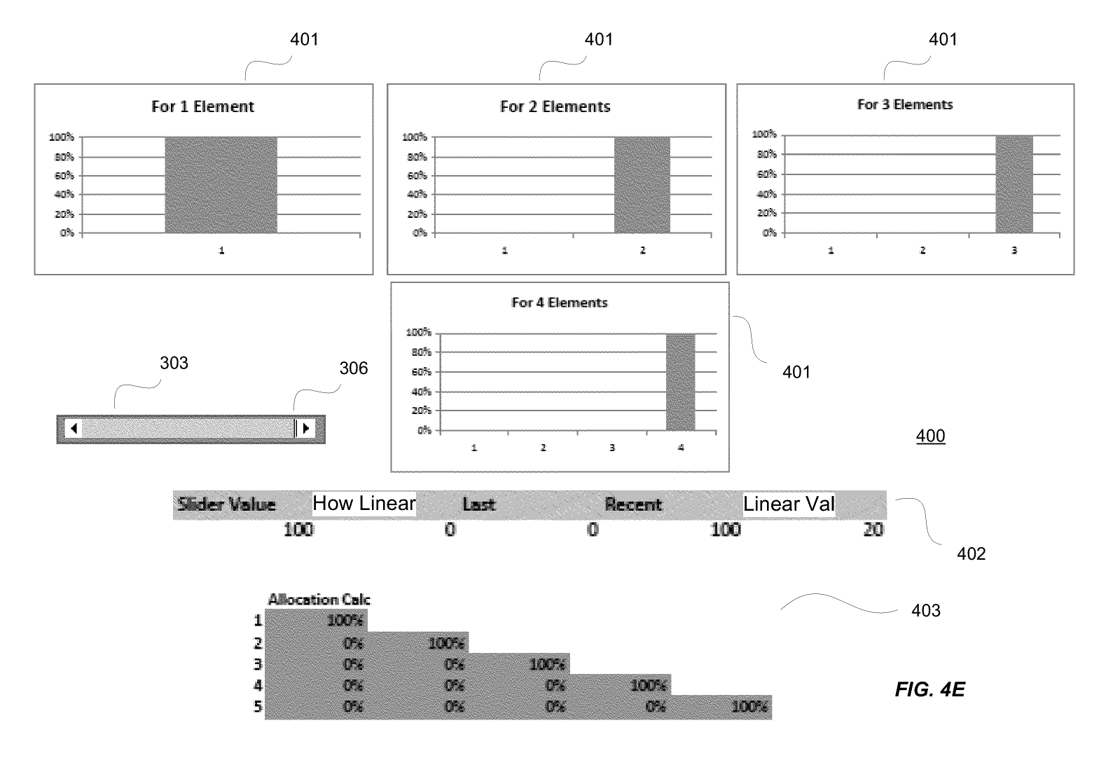

Referring now to FIGS. 4A through 4E, there are shown examples of an interactive detailed report 400 for dynamically allocating marketing results among categories according to one embodiment of the present invention. In one embodiment, detailed report 400 is implemented as a spreadsheet that is part of the same workbook as the spreadsheet for implementing report 300. Thus, in a spreadsheet application such as Microsoft Excel, user 202 can move from one report to another by clicking on tabs to move from one spreadsheet to another within a workbook. Techniques for organizing spreadsheets within workbooks, and for navigating among spreadsheets within a workbook, are well known in the art.

One skilled in the art will recognize that the particular layouts shown in the examples are merely illustrative, and that the claimed invention can be implemented with different layouts and elements. FIGS. 4A through 4E are examples of a report 400 showing detailed data for an allocation corresponding to that depicted in summary report 300 depicted in FIGS. 3A through 3E, respectively. Slider 303 is again shown, with element 306 in the leftmost position. In one embodiment, user 202 can manipulate slider 303 in the same manner as was described above in connection with report 300, and any changes made in one of reports 300 or 400 is reflect in the other report.

Table 402 indicates the following values:
a current numeric value corresponding to the slider position (in one embodiment, this ranges from 0 to 100);
a “how linear” value indicating how much the slider position deviates from a middle position representing a simple linear allocation among channels; in one embodiment, for a slider value ranging from 0 to 100, the “how linear” value is calculated as follows:

How linear value=100−2*|slider value−50|
a “last” value, calculated as follows:

If slider value <50, last value=100−(How linear value);

otherwise last value=0
a “recent” value, calculated as follows:

If slider value >50, recent value=100−(How linear value);

otherwise recent value=0
a “Linear” value, which in this example is fixed at 20

Table 403 depicts allocation calculations based on the values in table 402. As shown in the example, in one embodiment table 403 depicts allocations for different numbers of elements, or touches. In one embodiment, as depicted in the example, the rows in table 403 are calculated as follows:
Row 1 specifies an allocation when only one touch took place. It is fixed at 100%
Row 2 specifies an allocation when two touches took place. Column 1, representing the allocation for the initial touch, is determined as equal to (100−slider value). Column 2, representing the allocation for the second touch, is determined as equal to the slider value.
Row 3 specifies an allocation when three touches took place. Column 1, representing the allocation for the initial touch, is determined as equal to ((How linear value)/3+(last value)). Column 2, representing the allocation for the second touch, is determined as equal to ((How linear value)/3). Column 3, representing the allocation for the third touch, is determined as equal to ((How linear value)/3+(recent value)).
Row 4 specifies an allocation when four touches took place. Column 1, representing the allocation for the initial touch, is determined as equal to ((How linear value)/4+(last value)). Columns 2 and 3, representing the allocations for the second and third touches respectively, are each determined as equal to ((How linear value)/4). Column 4, representing the allocation for the fourth touch, is determined as equal to ((How linear value)/4+(recent value)).
Row 5 specifies an allocation when five touches took place. Column 1, representing the allocation for the initial touch, is determined as equal to ((How linear value)/5+(last value)). Columns 2, 3, and 4 representing the allocations for the second, third, and fourth touches respectively, are each determined as equal to ((How linear value)/5). Column 5, representing the allocation for the fifth touch, is determined as equal to ((How linear value)/5+(recent value)).

Thus, in the example shown, for allocations among three or more touches: when the slider value is less than 50 (closer to the left side than to the right), the initial touch is given an allocation based on the position of the slider, and the remaining available allocation is divided equally among the other touches; when the slider value is greater than 50 (closer to the right side than to the left), the last touch is given an allocation based on the position of the slider, and the remaining available allocation is divided equally among the other touches.

Graphs 401 are visual depictions of the allocation calculations shown in table 403.

In one embodiment, values in tables 402 and 403, along with graphs 401 are updated substantially instantaneously in response to changes to slider 303.

One skilled in the art will recognize that other calculations can be performed to derive allocations based on the position of element 306 in slider 303. The particular allocation calculation described herein is merely exemplary.

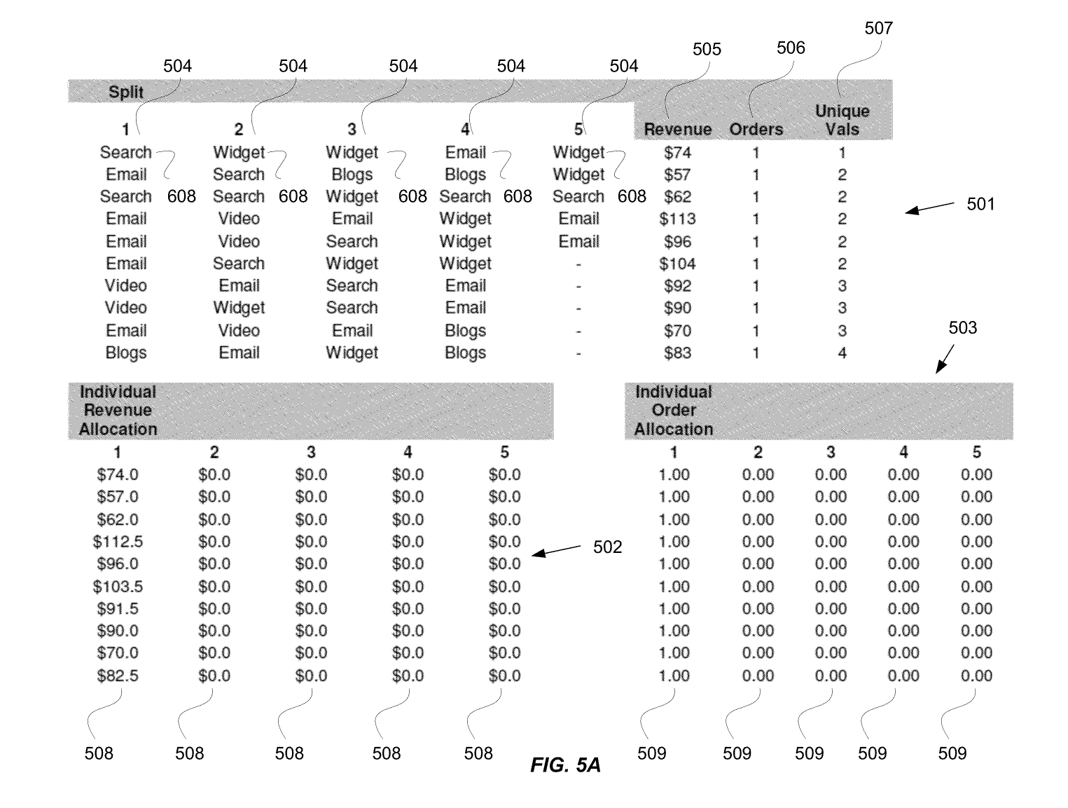

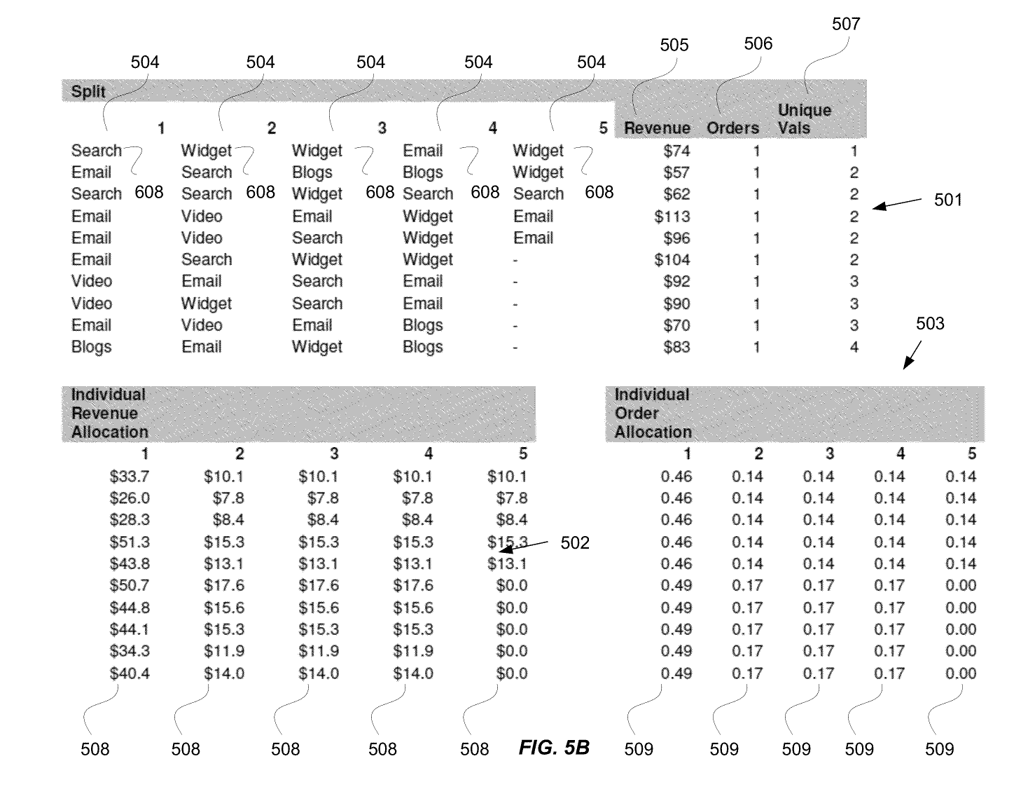

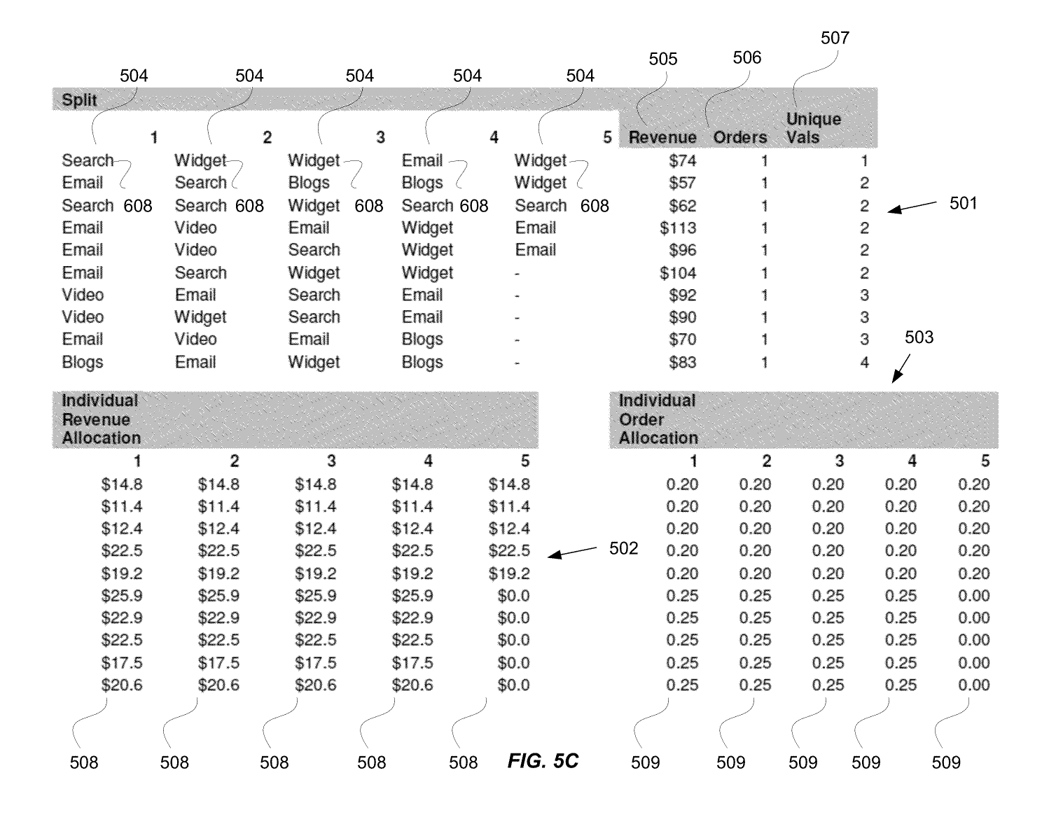

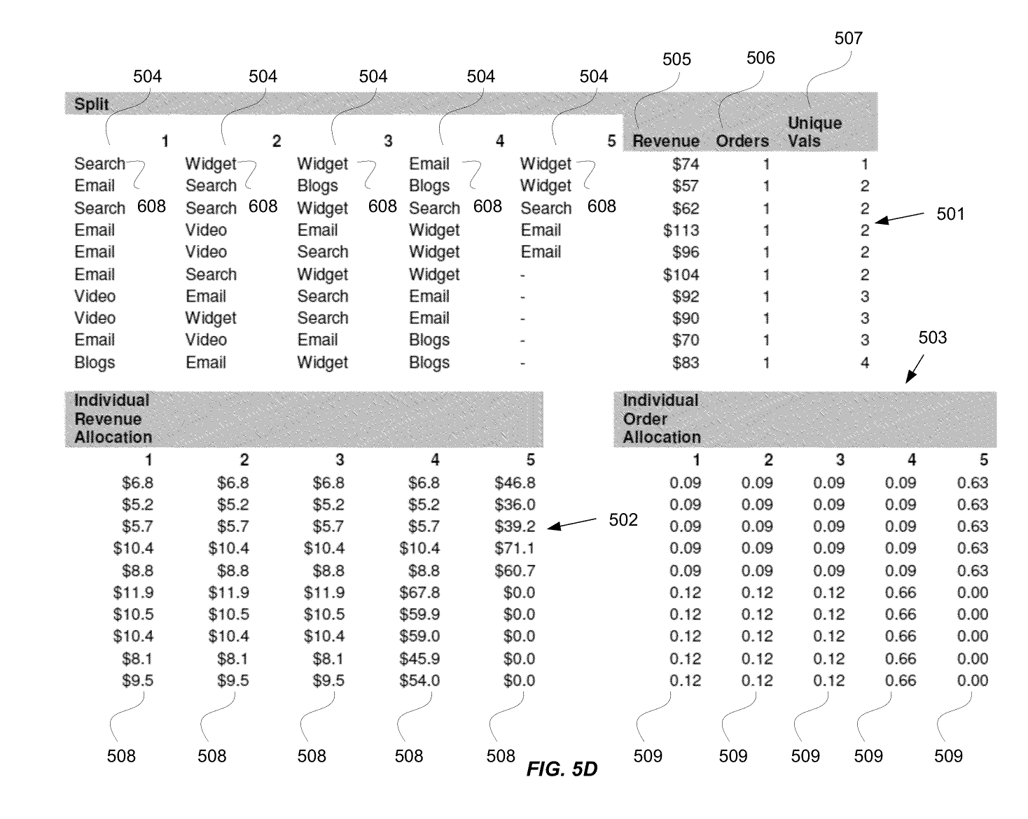

In one embodiment, interactive detailed report 400 also includes tables containing values for specific entries representing sequences of touches, based on the allocation calculation shown in table 403. Referring now to FIGS. 5A through 5E, there are shown examples of tables 501, 502, 503 showing allocations among touches for some of the entries depicted in table 600 of FIG. 6, as well as other supporting data for summary report 300. Tables 501, 502, 503 can be provided as part of report 400 or as a separate page or report. Alternatively, tables 501, 502, 503 can be generated internally but not generally available for viewing.

In one embodiment, tables 501, 502, 503 are implemented as one or more spreadsheets that is/are part of the same workbook as the spreadsheets for implementing report 300 and/or report 400. Thus, in a spreadsheet application such as Microsoft Excel, user 202 can move from one report to another by clicking on tabs to move from one spreadsheet to another within a workbook. Techniques for organizing spreadsheets within workbooks, and for navigating among spreadsheets within a workbook, are well known in the art.

Table 501 shows the same data as table 600, after individual touches have been extracted from column 602 and split into separate columns. Thus, each split column 504 depicts a touch; if more than one touch is associated with an order or other event, then more than one split column 504 is populated. Touch descriptor 608 are shown in split columns 504; these are extracted from column 602 of table 600 using delimiter 601 and offset columns 605.

Thus, for example, the first row of table 501 includes five populated split columns 504 containing touch descriptors 608 for “search”, “widget”, “widget”, “email”, and “widget”. These touch descriptors 608 have been extracted from the first row of table 600, which contains an entry having the string “Search>Widget>Widget>Email>Widget”. Data from columns 604 to 607 of table 600, including offsets 0, 7, 41, 21, and 27 shown in columns 605, facilitate the extraction of touch descriptors 608 from the entry in column 602 of table 600.

Table 501 also includes revenue column 505 and orders column 506 which replicate values from columns 603 and 604 of table 600, respectively. Unique vals column 507 indicates the number of unique occurrences of a touch descriptor 608 in the first split column 504.

Table 502 depicts individual revenue allocation assigned to each of the touches shown in columns 504 of table 501, for each order or other event. The individual revenue allocation is based on the current position of element 306 in slider 303. The total revenue allocation for any particular row of table 502 is equal to the revenue shown in column 505 of table 501.

The values in table 502 as shown in the examples of FIG. 5A to 5E correspond respectively to the slider element 306 positions shown in FIGS. 3A to 3E. Thus, in FIG. 5A, revenue is allocated to the initial touch for each row; first column 508 contains all of the revenue, while remaining columns 508 show zero values. This allocation corresponds to slider element 306 position shown in FIG. 3A, wherein element 306 is at the leftmost position within slider 303. Conversely, in FIG. 5E, revenue is allocated to the most recent touch for each row, which corresponds to the fifth column 508 for events having five touches, or the fourth column 508 for events having four touches; remaining columns 508 show zero values. This allocation corresponds to slider element 306 position shown in FIG. 3E, wherein element 306 is at the rightmost position within slider 303. FIGS. 5B, 5C, and 5D show intermediate allocations corresponding to intermediate slider element 306 positions as shown in FIGS. 3B, 3C, and 3D. Each individual revenue allocation shown in table 502 is calculated from the values in a corresponding allocation calculation table 403 for the current slider element 306 position. Thus, for example, individual revenue allocations shown in FIG. 5B are calculated from the values in allocation calculation table 403 shown in FIG. 4B.

Table 503 depicts individual order allocation assigned to each of the touches shown in columns 504 of table 501, for each order or other event. The individual order allocation is based on the current position of element 306 in slider 303. The total order allocation for any particular row of table 502 is equal to the orders value shown in column 506 of table 501.

The values in table 503 as shown in the examples of FIG. 5A to 5E correspond respectively to the slider element 306 positions shown in FIGS. 3A to 3E. Thus, in FIG. 5A, orders are allocated to the initial touch for each row; first column 508 contains all of the orders, while remaining columns 508 show zero values. This allocation corresponds to slider element 306 position shown in FIG. 3A, wherein element 306 is at the leftmost position within slider 303. Conversely, in FIG. 5E, orders are allocated to the most recent touch for each row, which corresponds to the fifth column 508 for events having five touches, or the fourth column 508 for events having four touches; remaining columns 508 show zero values. This allocation corresponds to slider element 306 position shown in FIG. 3E, wherein element 306 is at the rightmost position within slider 303. FIGS. 5B, 5C, and 5D show intermediate allocations corresponding to intermediate slider element 306 positions as shown in FIGS. 3B, 3C, and 3D. Each individual order allocation shown in table 502 is calculated from the values in a corresponding allocation calculation table 403 for the current slider element 306 position. Thus, for example, individual order allocations shown in FIG. 5B are calculated from the values in allocation calculation table 403 shown in FIG. 4B.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

In various embodiments, the present invention can be implemented as a system or a method for performing the above-described techniques, either singly or in any combination. In another embodiment, the present invention can be implemented as a computer program product comprising a computer-readable storage medium and computer program code, encoded on the medium, for causing a processor in a computing device or other electronic device to perform the above-described techniques.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared, transformed, and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware or hardware, and when embodied in software, can be down-loaded to reside on and be operated from different platforms used by a variety of operating systems.

The present invention also relates to an apparatus for performing the operations herein. This apparatus may be specially constructed for the required purposes, or it may comprise one or more general-purpose computer(s) selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers and/or other electronic devices referred to in the specification may include a single processor or may be architectures employing multiple processor designs for increased computing capability. In one embodiment, some or all of the functional components described above are implemented as computer hardware including processors performing the above-described steps under the control of software.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

Accordingly, in various embodiments, the present invention can be implemented as software, hardware, or other elements for controlling a computer system, computing device, or other electronic device, or client/server architecture, or any combination or plurality thereof. Hardware for implementing the system of the present invention can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the invention (or components of the invention) include: a mobile phone, personal digital assistant, smartphone, kiosk, desktop computer, laptop computer, consumer electronic device, television, set-top box, or the like. An electronic device for implementing the present invention may use an operating system such as, for example, Microsoft Windows Vista available from Microsoft Corporation of Redmond, Wash., or any other operating system that is adapted for use on the device.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

While the invention has been particularly shown and described with reference to a preferred embodiment and several alternate embodiments, it will be understood by persons skilled in the relevant art that various changes in form and details can be made therein without departing from the spirit and scope of the invention.

1. A computer-implemented method, comprising:
performing, by one or more computing devices:
receiving data describing past consumer exposures to marketing items;
measuring past revenue events, each revenue event being associated with at least one consumer exposure to at least one of the marketing items;
generating, based on the received data describing consumer exposures to marketing items and based on the measured past revenue events, an interactive report specifying at least one allocation of at least one measured past revenue event to a plurality of the marketing items, the at least one allocation being based on an initial value of an allocation parameter, wherein the allocation specifies, for each different one of the plurality of marketing items, a respective contribution amount for attributing the at least one measured past revenue event to the respective different one of the plurality of the marketing items;
displaying the generated interactive report and a user interface element for adjusting the allocation parameter;
responsive to input manipulating the user interface element, determining a revised value of the allocation parameter; and
updating the interactive report to specify at least one revised allocation of the at least one measured past revenue event to the plurality of the marketing items, the at least one revised allocation being based on the revised value of the allocation parameter, wherein the revised allocation specifies, for each different one of the plurality of marketing items, a respective updated contribution amount for attributing the at least one measured past revenue event to the respective different one of the plurality of the marketing items.

2. The method of claim 1, wherein displaying a user interface element for adjusting the value of the allocation parameter comprises displaying a control for specifying the allocation parameter value along a continuum of allocation parameter values.

3. The method of claim 2, wherein the at least one measured past revenue related event is associated with a plurality of consumer exposures to marketing items, and wherein said determining a revised value of the allocation parameter comprises:
determining a position of the control along the continuum of allocation parameters;
if the control is positioned at a first endpoint of the continuum, determining the revised value of the allocation parameter to allocate marketing results based on measured past initial consumer exposures to a marketing item;
if the control is positioned at a second endpoint of the continuum, determining the revised value of the allocation parameter to allocate marketing results based on a most recent measured past consumer exposure to a marketing item;
if the control is positioned between at the midpoint of the continuum, determining the revised value of the allocation parameter to allocate the marketing results based on an equal attribution to respective consumer exposures of a plurality of the consumer exposures to the marketing items;
if the control is positioned between the first endpoint of the continuum and the midpoint of the continuum, determining the revised value of the allocation parameter to allocate a portion of the marketing results to the initial consumer exposure to a marketing item, and to allocate the remaining marketing results based on an equal attribution to respective consumer exposures of a first plurality of other consumer exposures to the marketing items, wherein the portion of the marketing results allocated to the initial consumer exposure is determined by the proximity of the control to the first endpoint of the continuum; and
if the control is positioned between the midpoint of the continuum and the second endpoint of the continuum, determining the revised value of the allocation parameter to allocate a portion of the marketing results to the most recent consumer exposure to a marketing item, and to allocate the remaining marketing results based on an equal attribution to respective consumer exposures of a second plurality of other consumer exposures to the marketing items, wherein the portion of the marketing results allocated to the most recent consumer exposure is determined by the proximity of the control to the second endpoint of the continuum.

4. The method of claim 1, wherein displaying a user interface element for adjusting the value of the allocation parameter comprises displaying a slider control.

5. The method of claim 1, wherein the at least one measured past revenue event comprises a purchase.

6. The method of claim 1, wherein the at least one measured past revenue event is associated with consumer exposures to marketing items associated with at least two categories of the marketing items, and wherein said generating the interactive report specifying at least one allocation of the at least one measured past revenue event comprises generating the interactive report specifying an allocation of the at least one measured past revenue event among the at least two categories of marketing items.

7. The method of claim 1, wherein the at least one measured past revenue event is associated with consumer exposures to at least two marketing channels of the marketing items, and wherein said generating the interactive report specifying at least one allocation of the at least one measured past revenue event comprises generating the interactive report specifying an allocation of the at least one measured past revenue event among the at least two marketing channels.

8. The method of claim 1, wherein the at least one measured past revenue event is associated with at least two consumer exposures to the marketing items.

9. The method of claim 8, wherein each consumer exposure of the at least two consumer exposures to the marketing items is associated with a date, and wherein the value of the allocation parameter specifies a relative weight to be assigned to each category of the marketing items associated with a consumer exposure to a marketing item, wherein the allocation parameter is based on at least one of relative primacy and relative recency of the consumer exposure as compared with other consumer exposures.

10. The method of claim 1, further comprising:
at the input device, receiving additional user input manipulating the user interface element for adjusting the value of the allocation parameter;
at the processor, responsive to the additional user input, determining a further revised value of the allocation parameter;
at the processor, further updating the interactive report to specify at least one further revised allocation of the at least measured past one revenue event, the at least one further revised allocation being based on the further revised value of the allocation parameter; and
at the display device, displaying the further updated interactive report.

11. The method of claim 1, wherein the steps of determining a revised value of the allocation parameter, updating the interactive report, and displaying the updated interactive report are performed substantially instantaneously responsive to the user input manipulating the user interface element.

12. The method of claim 1, wherein the interactive report comprises an indication of at least one marketing result selected from the group consisting of:
a total revenue allocated to each of a plurality of marketing campaigns;
a total revenue allocated to each of a plurality of marketing channels;
a total profit allocated to each of a plurality of marketing campaigns;
a total profit allocated to each of a plurality of marketing channels;
a total return on investment allocated to each of a plurality of marketing campaigns;
a total return on investment allocated to each of a plurality of marketing channels;
a total number of orders allocated to each of a plurality of marketing campaigns; and
a total number of orders allocated to each of a plurality of marketing channels.

13. The method of claim 1, wherein the interactive report comprises, for each of a plurality of revenue events, at least one indication of at least one marketing result selected from the group consisting of:
a revenue allocated to each of a plurality of marketing campaigns;
a revenue allocated to each of a plurality of marketing channels;
a profit allocated to each of a plurality of marketing campaigns;
a profit allocated to each of a plurality of marketing channels;
a return on investment allocated to each of a plurality of marketing campaigns;
a return on investment allocated to each of a plurality of marketing channels;
a number of orders allocated to each of a plurality of marketing campaigns; and
a number of orders allocated to each of a plurality of marketing channels.

14. The method of claim 1, wherein the generated interactive report comprises a computer-readable spreadsheet document.

15. The method of claim 1, further comprising storing the updated interactive report in an electronic storage device.

16. The method of claim 1, further comprising:
at the processor, receiving, from an automated system, an instruction to adjust the value of the allocation parameter;
at the processor, responsive to the instruction, determining another revised value of the allocation parameter;
at the processor, updating the interactive report to specify at least one other revised allocation of at least other measured past one revenue event, the at least one other revised allocation being based on the other revised value of the allocation parameter; and
at the display device, displaying the interactive report updated to specify the at least one other revised allocation.

17. A computer-implemented method, comprising:
performing, by one or more computing devices:
receiving data describing past consumer exposures to marketing items;
measuring past revenue events, each revenue event being associated with at least one consumer exposure to at least one of the marketing items;
automatically determining an initial value for an allocation parameter;
automatically determining at least one adjusted value for the allocation parameter;
generating, based on the received data describing consumer exposures to the marketing items and based on the measured past revenue events, a report specifying, for each determined adjusted value of the allocation parameter, at least one allocation of at least one measured past revenue event to a plurality of the marketing items, the at least one allocation being based on the respective determined adjusted value of the allocation parameter, wherein the allocation specifies, for each different one of the plurality of marketing items, a respective contribution amount for attributing the at least one measured past revenue event to the respective different one of the plurality of the marketing items; and
displaying the generated report.

18. A computer program product, comprising:
a computer-readable storage medium; and
computer program code, encoded on the medium, programmatically configured to cause a processor to perform:
receiving data describing consumer exposures to marketing items;
measuring past revenue events, each revenue event being associated with at least one consumer exposure to at least one of the marketing items;
generating, based on the received data describing consumer exposures to marketing items and based on the measured past revenue events, an interactive report specifying at least one allocation of at least one measured past revenue event to a plurality of the marketing items, the at least one allocation being based on an initial value of an allocation parameter, wherein the allocation specifies, for each different one of the plurality of marketing items, a respective contribution amount for attributing the at least one measured past revenue event to the respective different one of the plurality of the marketing items;
displaying the generated interactive report and a user interface element for adjusting the allocation parameter;
responsive to input manipulating the user interface element, determining a revised value of the allocation parameter; and
updating the interactive report to specify at least one revised allocation of the at least one measured past revenue event to the plurality of the marketing items, the at least one revised allocation being based on the revised value of the allocation parameter, wherein the revised allocation specifies, for each different one of the plurality of marketing items, a respective updated contribution amount for attributing the at least one measured past revenue related event to the respective different one of the plurality of the marketing items.

19. The computer program product of claim 18, wherein the computer program code for displaying a user interface element for adjusting the value of the allocation parameter comprises computer program code for displaying a control for specifying the allocation parameter value along a continuum of allocation parameter values.

20. The computer program product of claim 19, wherein the at least one measured past revenue event is associated with a plurality of consumer exposures to marketing items, and wherein the computer program code for determining a revised value of the allocation parameter comprises:
computer program code for, responsive to the control being positioned at a first endpoint of the continuum, determining the revised value of the allocation parameter to allocate marketing results based on measured past initial consumer exposures to a marketing item;
computer program code for, responsive to the control being positioned at a second endpoint of the continuum, determining the revised value of the allocation parameter to allocate marketing results based on a most recent measured past consumer exposure to a marketing item;
computer program code for, responsive to the control being positioned between at the midpoint of the continuum, determining the revised value of the allocation parameter to allocate the marketing results based on an equal attribution to respective consumer exposures of a plurality of the consumer exposures to the marketing items;
computer program code for, responsive to the control being positioned between the first endpoint of the continuum and the midpoint of the continuum, determining the revised value of the allocation parameter to allocate a portion of the marketing results to the initial consumer exposure to a marketing item, and to allocate the remaining marketing results based on an equal attribution to respective consumer exposures of a first plurality of other consumer exposures to the marketing items, wherein the portion of the marketing results allocated to the initial consumer exposure is determined by the proximity of the control to the first endpoint of the continuum; and
computer program code for, responsive to the control being positioned between the midpoint of the continuum and the second endpoint of the continuum, determining the revised value of the allocation parameter to allocate a portion of the marketing results to the most recent consumer exposure to a marketing item, and to allocate the remaining marketing results based on an equal attribution to respective consumer exposures of a second plurality of other consumer exposures to the marketing items, wherein the portion of the marketing results allocated to the most recent consumer exposure is determined by the proximity of the control to the second endpoint of the continuum.

21. The computer program product of claim 18, wherein the computer program code for displaying a user interface element for adjusting the value of the allocation parameter comprises computer program code for displaying a slider control.

22. The computer program product of claim 18, further comprising computer program code, encoded on the medium, programmatically configured to cause a processor to perform:
receiving, from an automated system, an instruction to adjust the value of the allocation parameter;
responsive to the instruction, determining another revised value of the allocation parameter;
updating the interactive report to specify at least one other revised allocation of at least one other measured past revenue event, the at least one other revised allocation being based on the other revised value of the allocation parameter; and
displaying the interactive report updated to specify the at least one other revised allocation.

23. A computer program product, comprising:
a computer-readable storage medium; and
computer program code, encoded on the medium, programmatically configured to cause a processor to perform:
receiving data describing past consumer exposures to marketing items;
measuring past revenue events, each revenue event being associated with at least one consumer exposure to at least one of the marketing items;
automatically determining an initial value for an allocation parameter;
automatically determining at least one adjusted value for the allocation parameter;
generating, based on the received data describing consumer exposures to the marketing items and based on the measured past revenue events, a report specifying, for each determined adjusted value of the allocation parameter, at least one allocation of at least one measured past revenue event to a plurality of the marketing items, the at least one allocation being based on the respective determined adjusted value of the allocation parameter, wherein the allocation specifies, for each different one of the plurality of marketing items, a respective contribution amount for attributing the at least one measured past revenue event to the respective different one of the plurality of the marketing items; and
displaying the generated report.

24. A system, comprising:
one or more processors, for:
receiving data describing past consumer exposures to marketing items;
measuring past revenue events, each revenue event being associated with at least one consumer exposure to at least one of the marketing items;
generating, based on the received data describing consumer exposures to marketing items and based on the measured past revenue events, an interactive report specifying at least one allocation of at least one measured past revenue event to a plurality of the marketing items, the at least one allocation being based on an initial value of an allocation parameter, wherein the allocation specifies, for each different one of the plurality of marketing items, a respective contribution amount for attributing the at least one measured past revenue event to the respective different one of the plurality of the marketing items;
a display device, coupled to a processor of the one or more processors, for:
displaying the generated interactive report and a user interface element for adjusting the allocation parameter; and
an input device, coupled to a processor of the one or more processors, for receiving user input manipulating the user interface element for adjusting the value of the allocation parameter;
wherein:
responsive to the user input manipulating the user interface element, the one or more processors:
determines a revised value of the allocation parameter; and
updates the interactive report to specify at least one revised allocation of the at least one measured past revenue event to the plurality of the marketing items, the at least one revised allocation being based on the revised value of the allocation parameter, wherein the revised allocation specifies, for each different one of the plurality of marketing items, a respective updated contribution amount for attributing the at least one measured past revenue event to the respective different one of the plurality of the marketing items.

25. The system of claim 24, wherein the user interface element for adjusting the value of the allocation parameter comprises a control for specifying the allocation parameter value along a continuum of allocation parameter values.

26. The system of claim 25, wherein the at least one measured past revenue event is associated with a plurality of consumer exposures to marketing items, and wherein:
responsive to the control being positioned at a first endpoint of the continuum, the processor determines the revised value of the allocation parameter to allocate marketing results based on measured past initial consumer exposures to a marketing item;
responsive to the control being positioned at a second endpoint of the continuum, determines the revised value of the allocation parameter to allocate marketing results based on a most recent measured past consumer exposure to a marketing item;
responsive to the control being positioned between at the midpoint of the continuum, the processor determines the revised value of the allocation parameter to allocate the marketing results based on an equal attribution to respective consumer exposures of a plurality of the consumer exposures to the marketing items;
responsive to the control being positioned between the first endpoint of the continuum and the midpoint of the continuum, the processor determines the revised value of the allocation parameter to allocate a portion of the marketing results to the initial consumer exposure to a marketing item, and to allocate the remaining marketing results based on an equal attribution to respective consumer exposures of a first plurality of other consumer exposures to the marketing items, wherein the portion of the marketing results allocated to the initial consumer exposure is determined by the proximity of the control to the first endpoint of the continuum; and
responsive to the control being positioned between the midpoint of the continuum and the second endpoint of the continuum, the processor determines the revised value of the allocation parameter to allocate a portion of the marketing results to the most recent consumer exposure to a marketing item, and to allocate the remaining marketing results based on an equal attribution to respective consumer exposures of a second plurality of other consumer exposures to the marketing items, wherein the portion of the marketing results allocated to the most recent consumer exposure is determined by the proximity of the control to the second endpoint of the continuum.

27. The system of claim 24, wherein the user interface element for adjusting the value of the allocation parameter comprises a slider control.

28. The system of claim 24, wherein:
at least one of the one or more processors receives, from an automated system, an instruction to adjust the allocation parameter;
responsive to the instruction, the one or more processors:
determines another revised value of the allocation parameter; and
updates the interactive report to specify at least one other revised allocation of the at least one measured past revenue event, the at least one other revised allocation being based on the other revised value of the allocation parameter; and
responsive to the instruction, the display device displays the interactive report updated to specify the at least one other revised allocation.

29. A system, comprising:
one or more processors, for:
receiving data describing past consumer exposures to marketing items;
measuring past revenue events, each revenue event being associated with at least one consumer exposure to at least one of the marketing items;
automatically determining an initial value for an allocation parameter;
automatically determining at least one adjusted value for the allocation parameter;
generating, based on the received data describing consumer exposures to the marketing items and based on the measured past revenue events, a report specifying, for each determined adjusted value of the allocation parameter, at least one allocation of at least one measured past revenue event to a plurality of the marketing items, the at least one allocation being based on the respective determined adjusted value of the allocation parameter, wherein the allocation specifies, for each different one of the plurality of marketing items, a respective contribution amount for attributing the at least one measured past revenue event to the respective different one of the plurality of the marketing items; and
a display device, coupled to at least one of the one or more processors, for displaying the generated report.
